(19) United States
(12) Patent Application Publication
(10) Pub. No.: US 2017/0132629 A1
(43) Pub. Date: May 11, 2017

(54) CLOUD-SE-BASED CLOUD-SE SYSTEM, MOBILE TERMINAL, AND MOBILE PAYMENT METHOD THEREOF

(71) Applicant: MOZIDO CORFIRE - KOREA, LTD., Seoul (KR)

(72) Inventor: Yang OoK JUNG, Gyeonggi-do (KR)

(21) Appl. No.: 15/306,283

(22) PCT Filed: Apr. 27, 2015
(86) PCT No.: PCT/KR2015/004161

§ 371 Date: Jan. 10, 2017

(30) Foreign Application Priority Data
Apr. 25, 2014 (KR) 10-2014-0050121

(51) Int. Cl. G06Q 20/40; G06Q 20/38; G06Q 20/10; G06Q 20/34; H04L 29/08

(52) U.S. Cl. CPC G06Q 20/409; G06Q 20/34; H04L 67/10; H04L 67/18; G06Q 20/102; G06Q 20/4014; G06Q 20/3829

(57) ABSTRACT

Provided are a cloud-SE-based could SE system, a mobile terminal, and mobile payment method thereof. The mobile payment method, according to one embodiment of the present invention, comprises: measuring the quality of service of servers on which mobile card information has been saved and selecting same; and performing a mobile payment by obtaining mobile card information from the selected server. As a result, the mobile card information is obtained from a server providing the optimal QoS and used in the mobile payment, thereby increasing the probability of providing the mobile card information within a time required by standards, rules, policies, and recommendations, and ultimately increasing the probability of a successful mobile payment.

### TECHNICAL FIELD

The present invention relates to a method for mobile payment, and more particularly, the present invention relates to a method for mobile payment using a mobile card information stored in a cloud-secure element (SE).

### BACKGROUND ART

Technologies have been presented wherein a mobile card information is stored in a server instead of a mobile terminal, and acquiring the information from the server for mobile payment. However, these type of technologies have two disadvantages described below.

First, a mobile terminal cannot acquire the mobile information if it cannot access the server, due to failure to access the relevant network. To this end, a method is available which allows offline mobile payment with a mobile terminal only, without the mobile card information stored in a server, however, this method is not secure in the payment process.

Second, even if a mobile terminal succeeds in accessing the server, the time elapsed in acquiring the mobile card information is too long resulting in failure of settlement within predefined time period.

In any case, safe and reliable mobile payment cannot be accomplished, thus, demanding an appropriate solution.

### DETAILED DESCRIPTION OF THE INVENTION

### Technical Objects

An aspect of the present invention derived to solve above described problems is to provide a mobile terminal which acquires mobile card information from a server providing the optimum quality of service (QoS) and uses the information for mobile payment, and a method for mobile payment using the same.

In addition, another aspect of the present invention is to provide a mobile terminal which provides a secure offline mobile payment if mobile card information cannot be obtained from a server or the integrity of the information is inferior, and a method for mobile payment using the same.

### Means For Achieving the Technical Object

A method for achieving above objectives in accordance with an embodiment of the present invention comprises the steps of: measuring the QoS of the servers storing mobile card information; selecting one of the servers on the basis of the QoS; acquiring mobile card information from the selected server; and performing mobile payment using the mobile card information acquired.

In addition, a method for mobile payment in accordance with an embodiment of the present invention further comprises a step of locating the present position, and if the distance between the previously located position and the present position exceeds a threshold value, or the time elapsed exceeds a threshold time, the measuring step may be carried out again.

In addition, in the selecting step, a server offering the shortest waiting time from requesting the mobile card information to receiving the information can be selected.

In addition, the acquisition step can acquire the mobile card information from the selected server if the shortest waiting time is shorter than the time-out period of the payment terminal.

In addition, the acquisition step can acquire the mobile card information from the selected server if the shortest waiting time is longer than the time-out period of the payment terminal, by requesting the payment terminal to extend the time-out period and if the payment terminal can extend the time-out period.

In addition, the method for mobile payment in accordance with an embodiment of the present invention can further comprise the step of performing offline payment using the stored mobile card information.

In addition, the method for mobile payment in accordance with an embodiment of the present invention can further comprise the step of performing offline payment using the stored mobile card information if the access to the servers fail.

In addition, the offline mobile payment procedures can comprise the steps of: performing user authentication process using stored authentication information; if the user authentication is successful, checking the limitations of the mobile card in hand; and if there is no applicable limitation, performing mobile payment using the mobile card information.

In addition, the authentication information can be at least one of: a key generated with biometric data; a key set up by user input; and a token generated by any one of the servers.

In addition, the limitation can include at least one of the maximum allowable count of payment of the mobile card, payment limit and validity term.

In addition, the step of carrying out the mobile payment can be conducted using the mobile card information with the card emulation function provided by the operating system (OS).

In addition, the card emulation function can be a function that can emulate the mobile card information without physical security element (SE).

In addition, a mobile terminal in accordance with another embodiment of the present invention comprises: a communication unit for communicating with the servers storing mobile card information; and a processor for measuring the QoS of the servers, selecting one of the servers on the basis of the QoS, and conducting mobile payment by acquiring mobile card information from the selected server.

Meanwhile, a method for providing mobile card information in accordance with another embodiment of the present invention comprises the steps of: servers providing a mobile terminal with a mobile card information required for measuring QoS; the server transmitting the mobile card information stored in the SE to the mobile terminal; and the server synchronizing the stored mobile card information with other servers.

In addition, an SE-cloud system in accordance with still another embodiment of the present invention comprises a plurality of servers providing a mobile terminal with an information necessary for measuring QoS, transmitting a mobile card information stored in SE to the mobile terminal, and synchronizing stored mobile card information with those of other servers.

### Effect of the Invention

As described above, according to the embodiments of the present invention, the mobile card information acquired from the server offering the optimal QoS is used in the mobile payment, increasing the possibility that the mobile card information can be provided within the time period specified in standards, rules, policies, recommendations, etc., ultimately enhancing the success ratio of mobile payment. Higher success ratio of mobile payment leads to improved user convenience.

In addition, according to the embodiments of the present invention, diversified methods of authentication and limitations are applied to the offline mobile payment which is carried out if mobile card information cannot be obtained from servers or is inappropriate to prevent abuse or misappropriation of mobile cards and respect users' right for selection.

### BRIEF DESCRIPTION OF THE DRAWING

FIG. 1 is a schematic diagram illustrating a mobile payment system to which an embodiment of the present invention can be applied,

FIG. 2 is a detailed block diagram of the mobile terminal of FIG. 1,

FIG. 3 shows an exemplary QoS table,

FIG. 4 is a flow chart describing an online mobile payment method in accordance with an embodiment of the present invention,

FIG. 5 is a flow chart describing an offline mobile payment method in accordance with another embodiment of the present invention,

FIG. 6 is a flow chart showing a process for setting up preparation for offline payment, and

FIG. 7 is a block diagram of the servers constituting a cloud-SE system.

### PREFERABLE EMBODIMENT OF THE INVENTION

The present invention is described in further details below by referring to accompanying drawings.

1. Mobile Payment System

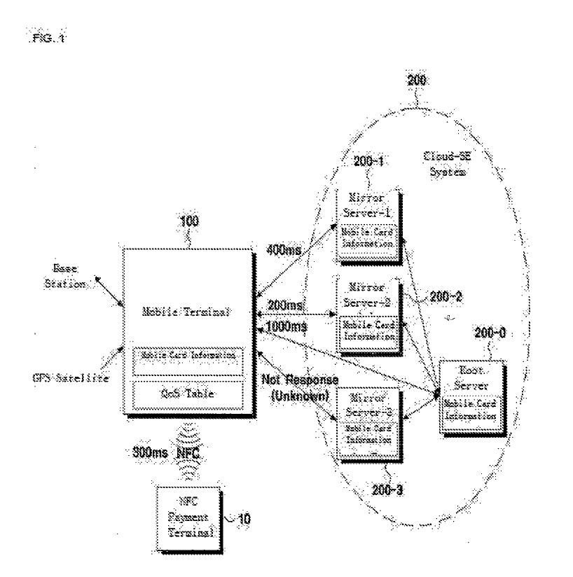

FIG. 1 is a schematic diagram illustrating a mobile payment system to which an embodiment of the present invention can be applied, As shown in FIG. 1, a mobile payment system to which the present invention is applicable comprises: a mobile terminal 100; a Near Field Communication (NFC) payment terminal 10; and a Cloud-Secure Element System (Cloud-SE system) (200).

The cloud-SE system 200 is for safe keeping of the mobile cards issued to the users of the mobile terminal 100. That is, the information of the mobile cards issued to the users of the mobile terminal 100 can be safely kept in an secure element (SE) based storage medium of a cloud-SE system 200.

The cloud-SE system 200 is a distributed system consisting of a Root Server 200-0 and

Mirror Servers 200-1, 200-2 and 200-3. The root server 200-0 stores users' mobile card information and provides mobile terminal 100 with the information at request through user authentication procedure.

The mirror servers 200-1, 200-2 and 200-3 are duplications of the root server 200-0, having the same information and functionalities of the root server 200-0, while differs only in their locations.

For this, the servers 200-0, 200-1, 200-2 and 200-3 constituting the cloud-SE system 200 synchronize stored mobile card information on a real-time-basis.

The mobile terminal 100 conducts mobile payment by providing NFC payment terminal 10 with a user's mobile card information. The mobile payment carried out by the mobile terminal 100 can be classified into online mobile payment and offline mobile payment.

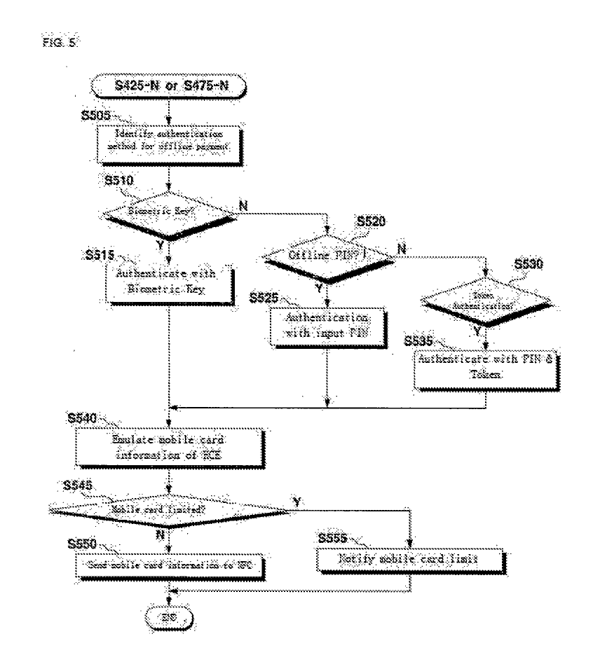

The offline mobile payment is performed using the mobile card information stored in the mobile terminal 100. This is a method for enabling mobile payment in the event that the mobile terminal 100 cannot access to a network, or even if accessible to a network, it fail to obtain mobile card information from the cloud-SE system 200 before it is too late. In order for security, various authentication methods and limitations are applicable, which will be described later referring to FIG. 5.

Online mobile payment uses mobile card information obtained from the servers 200-0, 200-1, 200-2 and 200-3.

In an online mobile payment, the mobile terminal 100 should obtain the mobile card information from a server offering the best QoS so that the mobile card information can be obtained within the time requested. For this, when requested by the mobile terminal 100, the servers 200-0, 200-1, 200-2 and 200-3 provide the mobile terminal 100 with the information necessary for estimating QoS (ultimately, the information to be included in the QoS Table to be described later).

FIG. 1, this requested time is indicated by “300 ms” as an example between the mobile terminal 100 and NFC payment terminal 10. The requested time can be the time period specified in standards, rules, policies or recommendations.

In order to keep the requested time, the mobile terminal 100 takes a latency time from between requesting to receiving mobile card information into consideration for estimating QoS.

Here, assume that the latency time periods for the root server 200-0, mirror server-1 (200-1), mirror server-2 (200-2) and mirror server-3 (200-3) are “1000 ms”, “400 ms”, “200 ms”, and “unknown” as shown in FIG. 1.

In this case, the mobile terminal 100 can obtain mobile card information from the mirror server-2 (200-2) so that mobile card information can be provided within the requested time of “300 ms”.

The mobile terminal 100 stores the latency time periods of the servers 200-0, 200-1, 200-2 and 200-3 on the QoS table.

In addition, the mobile terminal 100 locates the present position periodically using the signals from base stations or GPS (Global Positioning System) satellite signals. After a shift in position, the latency times are measured again to update the QoS table. This is because, since the locations of the servers 200-0, 200-1, 200-2 and 200-3 differ from each other, and the latency time will become difference according to the shift of the location of the mobile terminal 100.

In addition, after a long interval between the time measurement, the mobile terminal 100 measures the latency times again to update the QoS table. This is because, even if the mobile terminal 100 remains at the same or nearby location, the latency times might have been changed after some time.

2. Mobile Terminal

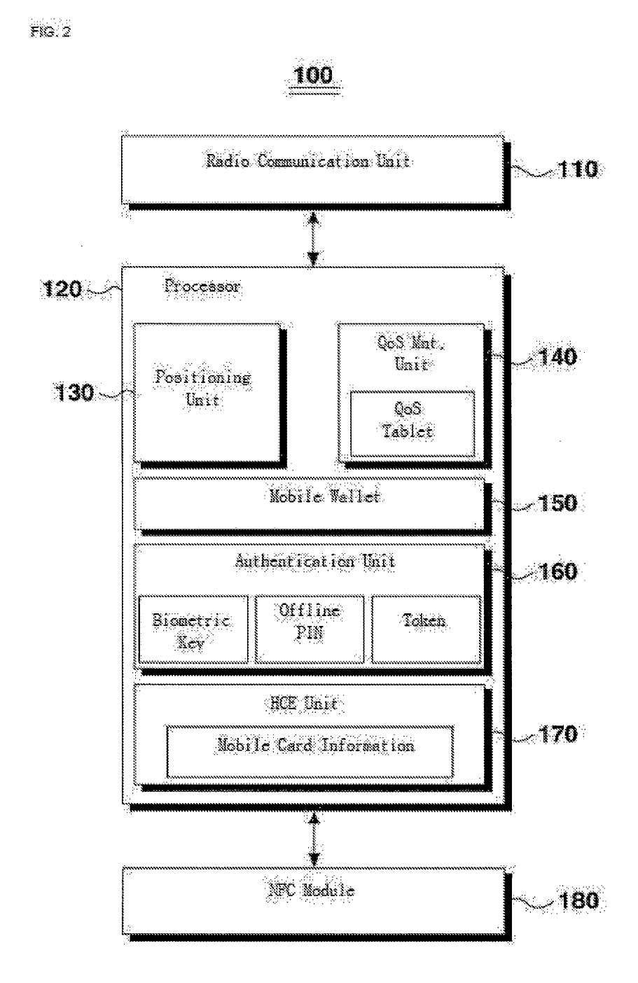

FIG. 2 is a detailed block diagram of the mobile terminal 100. As shown in FIG. 2, the mobile terminal 100 comprises a communication unit 110, a processor 120 and an NFC module 180.

The communication unit 110 accesses a network to establish communication with the servers 200-0,200-1, 200-2 and 200-3, communicates with a base station and received GPS satellite signals.

The processor 120 controls overall behavior of the mobile terminal 100 and, in relation with an embodiment of the present invention, it controls positioning unit 130, QoS measuring unit 140, mobile wallet 150, authentication unit 160 and Host Card Emulation (HCE) unit 170.

The mobile wallet 150 provides a user interface required for commanding and setting related with mobile payment. The mobile wallet 150 which is an application based on HCE, performs the processes required for mobile payment in linkage with the HCE unit 170.

The HCE unit 170 which is a component included in the OS of the mobile terminal 100 enables provides HCE function. The HCE function enable mobile card emulation even when there is no physical SE in the mobile terminal 100.

The HCE unit 170 safely stores mobile card information and performs offline mobile payment using the information.

In addition, if the mobile wallet 150 obtains mobile card information from the servers 200-0, 200-1, 200-2 and 200-3, the HCE unit 170 performs online mobile payment using the information.

The authentication unit 160 performs user authentication procedure required for offline mobile payment. According to the user setting, the authentication unit 160 performs user authentication on the basis of biometric key, Offline-Personal Identification Number (PIN) or token.

The positioning unit 130 measures the present position of the mobile terminal 100 using the base station signals received via the communication unit 110 or GPS satellite signals.

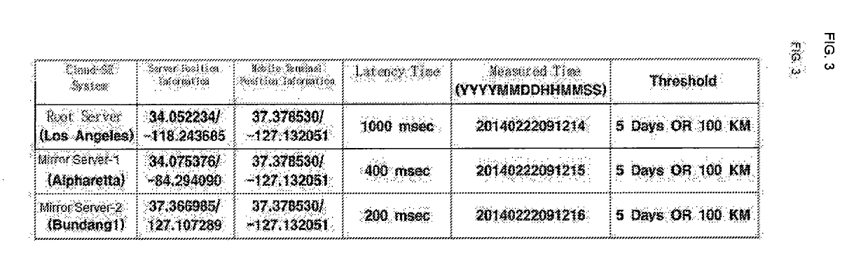

The QoS measuring unit 140 measures the QoS of the servers 200-0, 200-1, 200-2 and 200-3 to produce and update QoS table. FIG. 3 shows an exemplary QoS table produced and updated by the QoS measuring unit 140.

As shown in FIG. 3, the QoS table contains position information of the servers, position information of the mobile terminal, latency time, measured time, critical time and distance by the servers 200-0, 200-1 and 200-2 constituting the cloud-SE system 200. As marked “unknown” in FIG. 1, the mirror server-3 (200-3) was not listed as there was no response.

In order to include position information in the QoS table, the system is implemented is such a manner that the response to the message transmitted to the servers 200-0, 200-1, 200-2 and 200-3 for estimating QoS includes the position information.

3. Online Mobile Payment

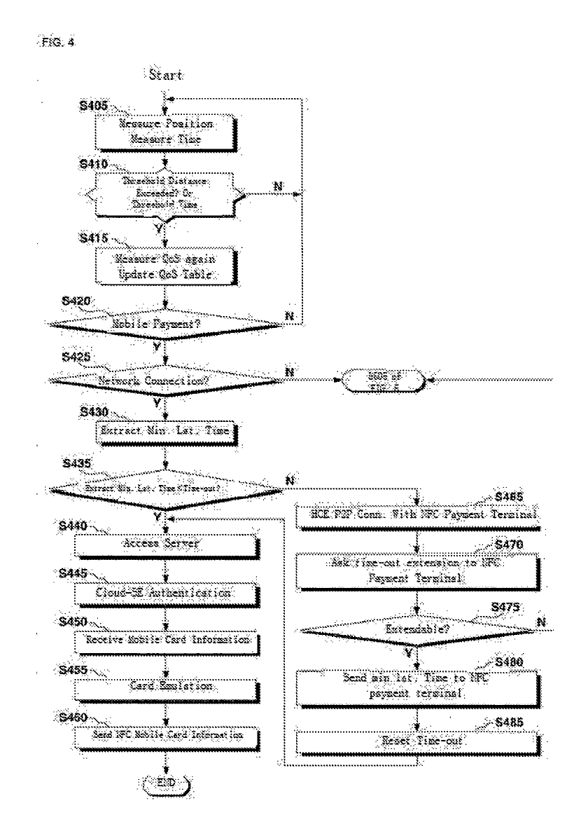

The procedure of online mobile payment using a mobile terminal 100 is described in detail below by referring to FIG. 4. FIG. 4 is a flow chart describing an online mobile payment method in accordance with an embodiment of the present invention,

As shown in FIG. 4, the positioning unit 130 measures the present location of the mobile terminal 100 and the processor 120 reads the present time (S405), in order to determine of the distance between the previously measured location and the present location exceeds the critical distance, or the time interval between the previously measured time to the present time exceeds the critical time (S410).

The measurement of the position and time at the step S405 are carried out on a regular basis, while there is no specific restriction to the measurement or reading period. In addition, the critical distance and time of the step S410 can be determined without any specific restriction.

At the step S410, if it was judged that the critical distance or time has been exceeded (S410-Y), the QoS measuring unit 140 measures the QoS of the servers 200-0, 200-1, 200-2 and 200-3 again to update QoS table. At the step S415, the position information, latency time, measured time and critical distance and time of the servers 200-0, 200-1, 200-2 and 200-3 and the mobile terminal 100 are updated.

When the user commands to execute a mobile payment by running the mobile wallet 150 of the mobile terminal 100 (S420), the mobile wallet 150 checks the network connection of the mobile terminal 100 (S425).

In the step S425, if it was confirmed that the mobile terminal is connected to the network (S425-Y), the mobile wallet 150 extracts the minimum latency time from the QoS table (S430).

In the step S430, if it was confirmed that the minimum latency time extracted is less than the time-out threshold (S435-Y), the mobile wallet 150 accesses the server offering the minimum latency time (S440). Here, the time-out threshold is the time for the mobile terminal 100 to send mobile card information to the NFC payment terminal 10 in the process of mobile payment. The requested time described earlier corresponds with the time-out for the NFC payment terminal 10.

Then, user authentication procedure is carried out between the mobile wallet 150 and server for accessing cloud-SE (S445), and if the authentication is successful, the mobile wallet 150 can receive the users mobile card information from the server (S450).

The HCE unit 170 emulates (S455) the mobile card information received at the step S450 and sends mobile card information to the NFC payment terminal 10 via the NFC module 180 (S460). Then, the payment authorization procedure is conducted by the interaction between the NFC payment terminal 10 and the credit card agency or payment agency.

Meanwhile, if the minimum latency time extracted at the step S430 is longer than the time-out period (S435-N), the HCE unit 170 sets up HCE P2P connection with an NFC payment terminal 10 (S465), and asks the NFC payment terminal 10 if the time-out can be extended (S470).

Here, in the steps S465 and S470, the expression; ‘NFC payment terminal 10’ refers to i) NFC payment terminal 10 itself if the NFC payment terminal 10 supports HCE P2P connection, or ii) if the NFC payment terminal 10 does not support HCE P2P connection, a POS terminal or seller's mobile terminal which is connected to the NFC payment terminal 10 and supports HCE P2P connection.

If the time-out can be extended (S475-Y), the HCE unit 170 transmits the minimum latency time extracted at the step S430 to the NFC payment terminal 10 (S480).

Then, when the NFC payment terminal 10 resets the time-out as the minimum latency time received at the step S480 and notifies the result (S485), the step S440 or S460 is executed.

4. Offline Mobile Payment

In FIG. 4, if the NFC payment terminal 10 cannot extend the time-out (S475-N), or the mobile terminal 100 is not connected to the network (S425-N), offline mobile payment is performed instead of an online mobile payment. The procedures are described in detail below referring to FIG. 5.

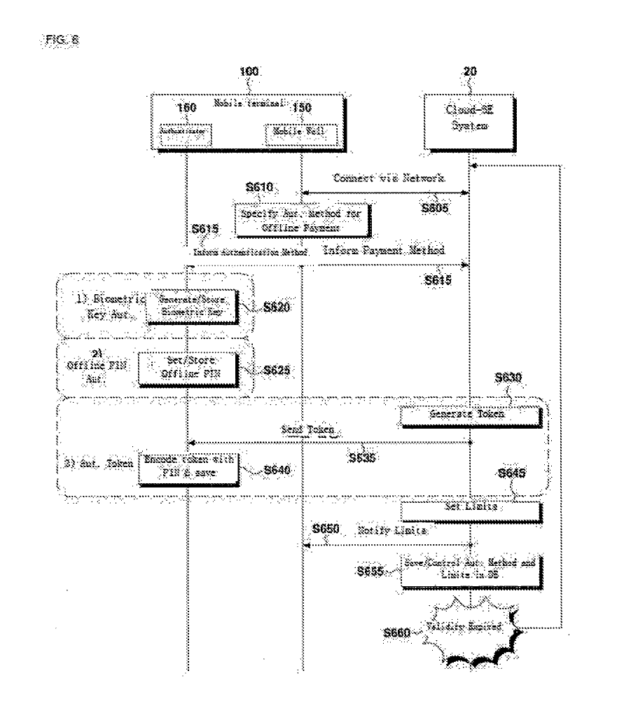

As shown in FIG. 5, if the case is pertinent to “S425-N” or “S475-N” of FIG. 4, the authentication unit 160 grasps an authentication method for an offline mobile payment (S505). The authentication method is preset. The procedures related with the authentication will be described in detail later referring to FIG. 6.

If the preset authentication method is a biometric key system (S510-Y), the authentication unit 160 reads the biometric information of the user, such as finger print or the iris of the eyes, and conducts the authentication procedure using the stored biometric key (S515).

If the preset authentication method is an offline-PIN system (S520-Y), the authentication unit 160 compares the PIN entered by the user with the stored offline-PIN and conduct the authentication procedure (S525).

If the preset authentication method is a token system (S530-Y), the authentication unit 160 conduct the authentication procedure by receiving the PIN from the user to verify if the encoded token in storage can be decoded (S535).

If the authentication is successful by any one of the above described methods, the HCE unit 170 emulates the mobile card information of its own (S540).

Then, the mobile wallet 150 or HCE unit 170 checks if there is any limitation imposed on the emulated mobile card (S545). In the step S545, the limitation may include the limit of maximum count of payment, payment limit and term of validity.

As such, in an offline mobile payment, such payments as exceeding maximum count of payment, payment limit, or after expiration of validity term cannot be implemented using a mobile card. Here, the payment limit can include at least one of: limit of payment amount per transaction; limit of payment amount per day; and limit of total payment amount.

If there is no limit in the step S545 (S545-N), the HCE unit 170 emulates transmits the mobile card information emulated in the step S450 to the NFC payment terminal 10 via the NFC module 180 (S550). Then, the payment authorization procedure is conducted by the interaction between the NFC payment terminal 10 and the credit card agency or payment agency.

On the other hand, if there is any limitation for use in the step S545 (S545-Y), the mobile wallet 150 generates a message telling a limited mobile card to notice the user that the mobile payment cannot be implemented (S555).

5. Preparation for Offline Settlement

As described earlier, various authentication methods and limitations are applicable to offline payments. The procedures related with the authentication will be described in detail below referring to FIG. 6. FIG. 6 is a flow chart showing a process for setting up preparation for offline payment, and

As shown in FIG. 6, firstly, the mobile wallet 150 and cloud-SE system 200 are interconnected via a network (S605). In the above step S605, the connection can be made with any one of the servers 200-0, 200-1, 200-2 and 200-3 constituting the cloud-SE system 200.

Then, the user specified the authentication method for the offline payment via the mobile wallet 150 (S610). In the step S610 above, the user may specify any one of the authentication methods; biometric key; offline PIN; and token.

The mobile wallet 150 notifies the authentication unit 160 and cloud-SE system 200 of the authentication method specified by the user in the step S610 (S615).

If the authentication method notified in the step S615 is a biometric key system, the authentication unit 160 obtains the user's finger print or iris of the eyes and generate and store biometric key therewith (S620).

If the authentication method notified in the step S615 is an offline-PIN system, the authentication unit 160 obtains the user's offline-PIN input, and saves the offline-PIN set up by the user (S625).

If the authentication method notified in the step S615 is a token system, the cloud-SE system 200 generates a token (S630), and sends the generated token to the authentication unit 160 (S635). Then, the authentication unit 160 encodes the token received in the step S635 using the PIN set by the user, and saves the encoded token (S640).

Then, the cloud-SE system 200 sets up limitations for the offline payment (S645), and sends the set-up limitations to the mobile wallet 150 (S650). In the step S645, the limitation may include the limit of maximum count of payment, payment limit and term of validity, as mentioned earlier.

Meanwhile, authentication method can be taken into consideration as a measure for the limitation, That is, the offline PIN system having relatively inferior security performance is applied with stricter limitations (less count and limit payment, shorter validity term), and the biometric key system of relatively superior security performance is applied with less strict limitations (more count and limit payment, longer validity term).

Then, the cloud-SE system 200 saves the authentication system received at the step S615 and the limitations set up at the step S645 in a DB for control. Meanwhile, the cloud-SE system 200 can also save and control the biometric key generated in the step S620, the offline PIN set up in the step S625, and the token generated in the step S630 in a DB.

Then, when the term of validity set up in the step S645 has been expired (S660), it returns to the step S605, when connected with the mobile wallet 150 via a network, and resets the authentication system and the necessary authentication information.

6. Cloud-SE System

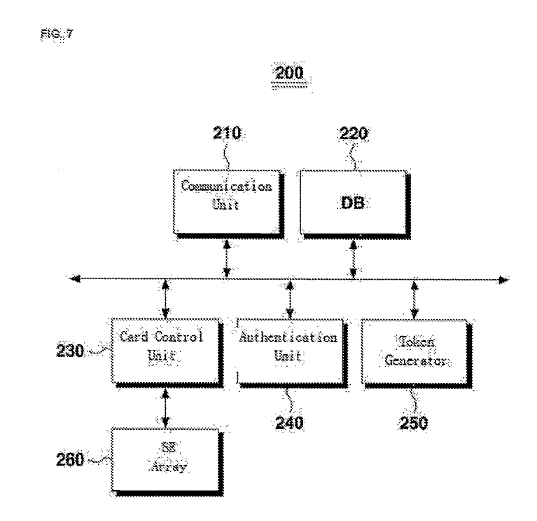

FIG. 7 is a block diagram of the servers 200-0, 200-1, 200-2 and 200-3 constituting the cloud-SE system 200. Because the servers 200-0, 200-1, 200-2 and 200-3 can be implemented in a same configuration, they are represented with reference number “200” in FIG. 7.

As shown in FIG. 7, the server 200 comprises a communication unit 210, a DB (database) 220, a card control unit 230, an authentication unit 240, a token generating unit, and an SE array 260.

The communication unit 210 supports communication between the server 200 and mobile terminal 100 by accessing a network. The communication unit 210, on request from the mobile terminal 100, provides the mobile terminal 100 with the information necessary for estimating QoS.

The DB 220 is a storage keeping user information, authentication information, limitation, etc. by user.

The SE array 260 is a set of SEs storing users' mobile card information. The card control unit 230 provides the mobile terminal 100 with the mobile card information stored in the SE array 260.

In addition, the card control unit 230 sets the limitations applicable to offline payment (step S645 of FIG. 6) and saves the generated limitations in the DB 220 for further control.

Further, the card control unit 230 issues or reissues mobile cards to the SE array 260, and performs life cycle (LC) control of the mobile cards issued to the SE array 260 including discarding, updating, locking, and unlocking.

The authentication unit 240 performs authentication procedures of the uses of the mobile terminal 100 requesting the mobile card information stored in the SE array 260. (See step S445 of FIG. 4.) In addition, the authentication unit 240 generates/discards key necessary for the issuance and discard of mobile cards by the card control unit 230.

The token generation unit 250 generates tokens (step S630 of FIG. 6), transfers generated tokens to the mobile wallet 130 and stores and controls them in the DB 220.

7. Modified Embodiments

The preferred embodiments of the mobile terminals and mobile payment methods in accordance with the present invention were described above. For example, the mobile terminals in accordance with an embodiment of the present invention perform online mobile payment by acquiring mobile card information from the server offering the optimal QoS, and if mobile card information cannot be obtained from the servers or obtained information is irrelevant, they conduct offline mobile payment based on stricter security measures.

In the embodiments described above, the numbers of the root server and the mirror servers were assumed to be one and three, however, the numbers are only illustrative and not limited.

In addition, it was assumed that the QoS table is updated when the location of the mobile terminal 100 has been changed significantly or a significant period of time has been elapsed, however, these conditions are subject to change. For example, a QoS table can be updated prior to a mobile payment, and in this case also, the limitations of position and time change may still be applied.

The provision of mobile card information may be delayed by QoS table update, thus, the QoS update is preferably as earlier as possible, e.g., right after execution of mobile wallet.

In addition, it was assumed that the authentication system applicable to offline mobile payment is determined by the user, other designation methods may be applied alternatively. Exemplary methods include: a time basis designation method wherein one of the three authentication methods generated by dividing the “hour+minute+second” of the present time by three (biometric key, offline-PIN, token authentication methods), and random designation method wherein one of the three authentication methods generated by dividing the random variable generated by the mobile wallet 130 by three.

Further, composite authentication method combining two or more authentication methods for offline mobile payment can also be implemented.

In addition, it would be obvious that the technical spirit of the present invention can also be applied to the recording media which can be read with a computer system installed with a software program enabling the implementation of the device and method in accordance with an embodiment of the present invention. In addition, the technical spirit in accordance with the embodiments of the present invention can also be implemented is a coded-form written in recording media which can be read with a computer system. The recording media readable with a computer system can be any data storage media that can store data and can be read with a computer system. For example, the recording media readable with a computer system can be ROM, RAM, CD-ROM, magnetic tape, floppy discs, optical discs, hard disc drives, etc. In addition, the code or software programs which are readable with a computer system stored in a recording medium readable with a computer system can be transmitted over a computer network.

The scope of the present invention is not limited to the preferable embodiment set forth and described above. Various modifications and additions can be made by those skilled in the pertinent art without departing from the scope of the present invention. Therefore, it will be understood that the appended claims are intended to cover all such modifications and embodiments

1. A method for mobile payment characterized by comprising the steps of: estimating the service qualities of the servers storing mobile card information;
selecting one of the servers on the basis of the service qualities;
acquiring mobile card information from the selected server; and
executing mobile payment using the acquired mobile card information.

2. A method for mobile payment in accordance with claim 1,
further comprising a step of measuring the present location, and
conducting the location measurement again when the distance between the previous location and present location exceeds a threshold distance or the time elapsed from the previous measurement exceeds a threshold time period.

3. A method for mobile payment in accordance with claim 1,
wherein the selecting step selects a server offering the shortest waiting time from requesting the mobile card information to receiving the information.

4. A method for mobile payment in accordance with claim 3,
wherein the acquisition acquires the mobile card information from the selected server if the shortest waiting time is shorter than the time-out period of the payment terminal.

5. A method for mobile payment in accordance with claim 3,
wherein the acquisition step comprises the steps of: requesting the payment terminal to extend the time-out period if the shortest latency time is longer than the time-out of the payment terminal; and
acquiring the mobile card information from the selected server if the payment terminal can extend the time-out.

6. A method for mobile payment in accordance with claim 5,
further comprising the step of performing offline mobile payment using the stored mobile card information, if the payment terminal cannot extend the time-out.

7. A method for mobile payment in accordance with claim 1,
further comprising the step of performing offline mobile payment using the stored mobile card information, if the servers are not accessible.

8. A method for mobile payment in accordance with claim 7,
wherein the offline mobile payment procedures comprising the steps of: performing user authentication procedure using stored authentication information;
if the user authentication is successful, checking the limitations of the mobile card in hand; and
if there are no applicable limitations, executing mobile payment using the mobile card information.

9. A method for mobile payment in accordance with claim 8,
wherein the authentication information can be at least one of: a key generated with biometric data; a key set up by user input; and a token generated by any one of the servers.

10. A method for mobile payment in accordance with claim 8,
wherein the limitation can include at least one of the maximum allowable count of payment of the mobile card, payment limit and validity term.

11. A method for mobile payment in accordance with claim 1,
wherein the step of carrying out the mobile payment can be conducted using the mobile card information with the card emulation function provided by the operating system (OS).

12. A method for mobile payment in accordance with claim 11,
wherein the card emulation function can be a function that can emulate the mobile card information without physical security element (SE).

13. A mobile terminal comprising: a communication unit communicating with the servers storing mobile card information; and
a processor for measuring the QoS of the servers, selecting one of the servers on the basis of the QoS, and conducting mobile payment by acquiring mobile card information from the selected server.

14. A method for providing mobile card information comprising the steps of: a server providing mobile terminal with information necessary for estimating service quality;
the server transmitting the mobile card information stored in the SE to the mobile terminal; and
the server synchronizing the stored mobile card information with other servers.

15. An SE-cloud system comprising a plurality of servers for providing a mobile terminal with information necessary for estimating quality of service, transmitting mobile card information stored in SE to the mobile terminal, and synchronizing stored mobile card information with those of other servers.
